(19) United States
(12) Patent Application Publication
(10) Pub. No.: US 2026/0267021 A1
(43) Pub. Date: Sep. 10, 2026

(54) Methods and Systems of Locally Attentive Full-Waveform Inversion

(71) Applicant: BP Corporation North America Inc., Houston, TX (US)

(72) Inventors: Madhav Vyas, Houston, TX (US); Joseph Anthony Dellinger, Houston, TX (US)

(73) Assignee: BP Corporation North America Inc., Houston, TX (US)

(21) Appl. No.: 19/557,484

(22) Filed: Mar. 5, 2026

Related U.S. Application Data
(60) Provisional application No. 63/767,102, filed on Mar. 5, 2025.

(51) Int. Cl. G01V 1/28; G01V 1/30

(52) U.S. Cl. CPC G01V 1/282; G01V 1/303; G01V 1/306

(57) ABSTRACT

A method includes obtaining a velocity model of a subsurface region; generating a first density model corresponding to the subsurface region; generating, based on the first density model, a second density model that corresponds to the subsurface region and that comprises different densities corresponding to at least one zone of interest of the subsurface region; obtaining, based on the first density model and the velocity model, first modeled data; obtaining, based on the second density model and the velocity model, second modeled data; obtaining, based on the first modeled data and the second modeled data, a data difference comprising additional modeled data corresponding to the different densities in the second density model; performing, on the data difference, signal processing to obtain an envelope of the data difference; and inputting, into a full-waveform inversion (FWI) optimization scheme and as a weight function, the envelope to obtain an optimized subsurface model.

### CROSS-REFERENCE TO RELATED APPLICATIONS

The present application claims priority to U.S. Provisional Application No. 63/767,102 filed on Mar. 5, 2025, and entitled “METHODS AND SYSTEMS OF LOCALLY ATTENTIVE FULL-WAVEFORM INVERSION,” which is hereby incorporated herein by reference in its entirety for all purposes.

### BACKGROUND

Seismic surveying is a geophysical technique used to investigate the subsurface structure of the Earth by sending shock waves or vibrations into the ground and analyzing the reflected waves. Seismic waves are reflected when they encounter boundaries between different layers of subsurface materials, such as rock, sediment, or fluid. These layers have different densities, which cause the seismic waves to change speed and direction upon encountering the boundary. When a seismic wave propagates through the Earth and strikes a boundary between materials of different densities, a part of the seismic wave energy is transmitted into the new layer and the remainder is reflected back toward the surface. The reflected seismic wave energy is observed at the surface as seismic data and may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. Furthermore, the seismic data observed by the receivers may also be used to create an image or profile of the corresponding subsurface region. Interpretation of these seismic images may provide a description of composition, density, and depth of subsurface materials and aids in resource extraction, hazard assessment, and environmental impact studies of the subsurface.

### SUMMARY

In an embodiment, a method comprises obtaining, based on seismic data, a velocity model of a subsurface region; generating, based on the seismic data, a first density model corresponding to the subsurface region; generating, based on the first density model, a second density model corresponding to the subsurface region, wherein the second density model comprises different densities corresponding to at least one zone of interest of the subsurface region; obtaining, based on the first density model and the velocity model, first modeled data; obtaining, based on the second density model and the velocity model, second modeled data; obtaining, based on the first modeled data and the second modeled data, a data difference, wherein the data difference comprises additional modeled data corresponding to the different densities in the second density model; performing, on the data difference, signal processing to obtain an envelope of the data difference; and inputting, into a full-waveform inversion (FWI) optimization scheme and as a weight function, the envelope to obtain an optimized subsurface model. In some embodiments, the method further comprises performing, on the data difference, a Hilbert transform to obtain the envelope; and performing thresholding, normalization, and scaling on the envelope before inputting the envelope. In certain embodiments, the FWI optimization scheme comprises at least one of a first elastic FWI optimization scheme comprising a density, a P-wave velocity, and an S-wave velocity; a second elastic FWI optimization scheme comprising the P-wave velocity and an impedance; a third elastic FWI optimization scheme comprising the P-wave velocity and the density; a first multi-parameter FWI optimization scheme comprising the density, the P-wave velocity, the S-wave velocity, and one or more an anisotropy parameter or an attenuation parameter; a second multi-parameter FWI optimization scheme comprising two or more components of the density, the P-wave velocity, the S-wave velocity, and one or more the anisotropy parameter or the attenuation parameter; or an acoustic FWI optimization scheme comprising the P-wave velocity. In some other embodiments, the method further comprises performing, on the data difference, a rectification process to obtain an absolute value of the data difference; and performing, on the absolute value of the data difference, a low-pass filtering to obtain the envelope. In other embodiments, the method further comprises performing thresholding, normalization, and scaling on the envelope. In certain embodiments, generating the first density model comprises setting an initial density model corresponding to the subsurface region as the first density model. In some embodiments, the method further comprises inserting, into the first density model and to areas corresponding to the at least one zone of interest, density contrast to obtain the second density model. In some embodiments, the method further comprises performing, on an initial velocity model, an FWI optimization scheme to obtain the velocity model. In other embodiments, the method further comprises subtracting the first modeled data from the second modeled data to obtain the data difference. In an embodiment, a computing system comprises a memory configured to store instructions; and one or more processors coupled to the memory and configured to execute the instructions to cause the computing system to obtain, based on seismic data, a velocity model of a subsurface region; generate, based on the seismic data, a first density model corresponding to the subsurface region; generate, based on the first density model, a second density model corresponding to the subsurface region, wherein the second density model comprises different densities corresponding to at least one zone of interest of the subsurface region; obtain, based on the first density model and the velocity model, first modeled data; obtain, based on the second density model and the velocity model, second modeled data; obtain, based on the first modeled data and the second modeled data, data difference, wherein the data difference comprises additional modeled data corresponding to the different densities in the second density model; perform, on the data difference, signal processing to obtain an envelope of the data difference; and input, into an FWI optimization scheme and as a weight function, the envelope to obtain an optimized subsurface model. The FWI here is defined to include all variants of full-waveform inversion. Certain examples of full-waveform inversion can use pressure and/or multi-component data. Certain examples of full-waveform inversion can use different approximations of physics (such as, for example, acoustic, elastic, visco-elastic, isotropic, and/or anisotropic). FWI can be used for different applications such as applications for estimating three-dimensional (3D) velocities, applications for performing multi-parameter inversion, applications for deriving reflectivity volumes, applications for determining four-dimensional (4D) difference volumes, applications for determining reflectivity gathers, and/or applications for determining probabilistic inversions, to name a few examples. In some embodiments, the one or more processors are further configured to execute the instructions to cause the computing system to perform, on the data difference, a Hilbert transform to obtain the envelope; and perform thresholding, normalization, and scaling on the envelope before inputting the envelope. In some other embodiments, the FWI optimization scheme comprises at least one of a first elastic FWI optimization scheme comprising a density, a P-wave velocity, and an S-wave velocity; a second elastic FWI optimization scheme comprising the P-wave velocity and an impedance; a third elastic FWI optimization scheme comprising the P-wave velocity and the density; a first multi-parameter FWI optimization scheme comprising the density, the P-wave velocity, the S-wave velocity, and one or more an anisotropy parameter or an attenuation parameter; a second multi-parameter FWI optimization scheme comprising two or more components of the density, the P-wave velocity, the S-wave velocity, and one or more the anisotropy parameter or the attenuation parameter; or an acoustic FWI optimization scheme comprising the P-wave velocity. In other embodiments, the one or more processors are further configured to execute the instructions to cause the computing system to perform, on the data difference, a rectification process to obtain an absolute value of the data difference; and perform, on the absolute value of the data difference, a low-pass filtering to obtain the envelope. In certain other embodiments, the one or more processors are further configured to execute the instructions to cause the computing system to perform thresholding, normalization, and scaling on the envelope. In some embodiments, the one or more processors are further configured to execute the instructions to cause the computing system to set an initial density model corresponding to the subsurface region as the first density model. In some other embodiments, the one or more processors are further configured to execute the instructions to cause the computing system to insert, into the first density model and to areas corresponding to the at least one zone of interest, density contrast to obtain the second density model. In some embodiments, the one or more processors are further configured to execute the instructions to cause the computing system to perform, on an initial velocity model, an FWI optimization scheme to obtain the velocity model. In other embodiments, the one or more processors are further configured to execute the instructions to cause the computing system to subtract the first modeled data from the second modeled data to obtain the data difference. In an embodiment, a computer program product comprising computer-executable instructions that are stored on a non-transitory computer-readable medium and that, when executed by one or more processors, cause a computing system to obtain, based on seismic data, a velocity model of a subsurface region; generate, based on the seismic data, a first density model corresponding to the subsurface region; generate, based on the first density model, a second density model corresponding to the subsurface region, wherein the second density model comprises different densities corresponding to at least one zone of interest of the subsurface region; obtain, based on the first density model and the velocity model, first modeled data; obtain, based on the second density model and the velocity model, second modeled data; obtain, based on the first modeled data and the second modeled data, data difference, wherein the data difference comprises additional modeled data corresponding to the different densities in the second density model; perform, on the data difference, signal processing to obtain an envelope of the data difference; and input, into a full waveform inversion (FWI) optimization scheme and as a weight function, the envelope to obtain an optimized subsurface model. In some embodiments, the computer-executable instructions, when executed by the one or more processors, further cause the computing system to perform, on the data difference, a Hilbert transform to obtain the envelope; and perform thresholding, normalization, and scaling on the envelope before inputting the envelope, wherein the FWI optimization scheme comprises at least one of a first elastic FWI optimization scheme comprising a density, a P-wave velocity, and an S-wave velocity; a second elastic FWI optimization scheme comprising the P-wave velocity and an impedance; a third elastic FWI optimization scheme comprising the P-wave velocity and the density; a first multi-parameter FWI optimization scheme comprising the density, the P-wave velocity, the S-wave velocity, and one or more an anisotropy parameter or an attenuation parameter; a second multi-parameter FWI optimization scheme comprising two or more components of the density, the P-wave velocity, the S-wave velocity, and one or more the anisotropy parameter or the attenuation parameter; or an acoustic FWI optimization scheme comprising the P-wave velocity.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system according to various embodiments disclosed herein;

FIG. 2 is a schematic diagram of an embodiment of a system for performing a marine seismic survey according to various embodiments disclosed herein;

FIG. 3 is a schematic diagram of an embodiment of a system for performing a land-based seismic survey according to various embodiments disclosed herein;

FIG. 4 is a block diagram of an embodiment of a computer system that may perform operations described herein based on data acquired via the marine survey system of FIG. 2 and/or the land survey systems of FIG. 3 according to various embodiments described herein;

FIG. 5 depicts a velocity model of a subsurface region according to various embodiments described herein;

FIG. 6A depicts a density model corresponding to the subsurface region according to various embodiments described herein;

FIG. 6B depicts another density model with added density contrast corresponding to the subsurface region according to various embodiments described herein;

FIG. 7A depicts first model data corresponding to the subsurface region according to various embodiments described herein;

FIG. 7B depicts second model data corresponding to the subsurface region according to various embodiments described herein;

FIG. 7C depicts data difference corresponding to the subsurface region according to various embodiments described herein;

FIG. 8 depicts an envelope corresponding to the data difference according to various embodiments described herein;

FIG. 9 depicts another envelope corresponding to the data difference according to various embodiments described herein;

FIG. 10 is a flowchart of an embodiment of a method of locally attentive Full-Waveform Inversion (FWI) according to various embodiments described herein; and

FIG. 11 depicts velocity model of a subsurface according to various embodiments described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to...” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

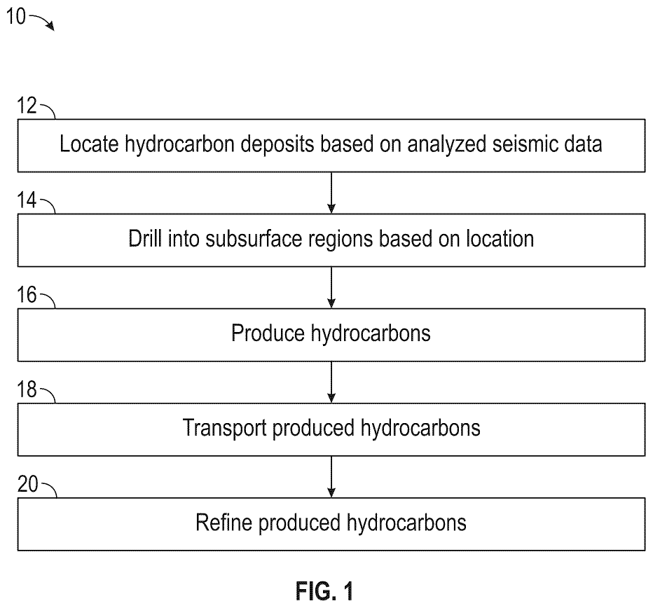

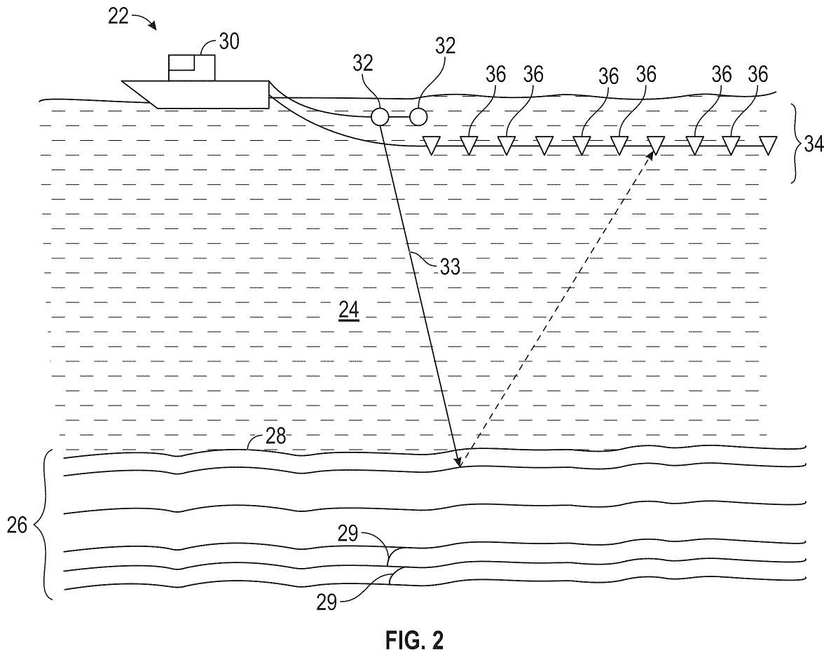

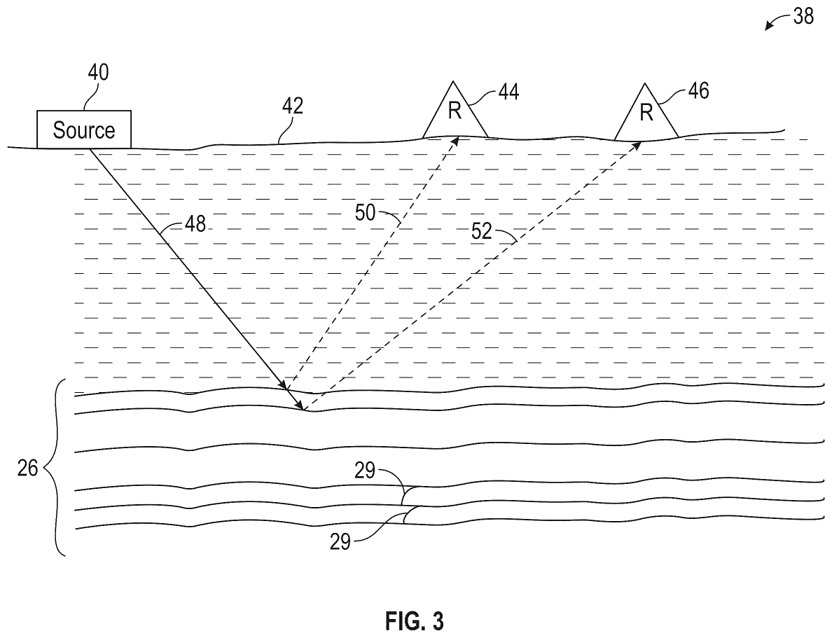

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth, in particular receivers in the water column or on the sea floor (e.g. “ocean-bottom nodes”, “ocean-bottom cables”, or “distributed acoustic sensing” fiber-optic cables). The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being interacted with various geological formations (e.g., salt domes, faults, folds, etc., represented schematically in FIG. 2 as subsurface reflectors 29) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator, dynamite, thumper, etc) may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of, or otherwise interact with, the geological formations (e.g., subsurface reflectors 29) and then be acquired or observed by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may interact with one or more different geological formations and then be received by one or more receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

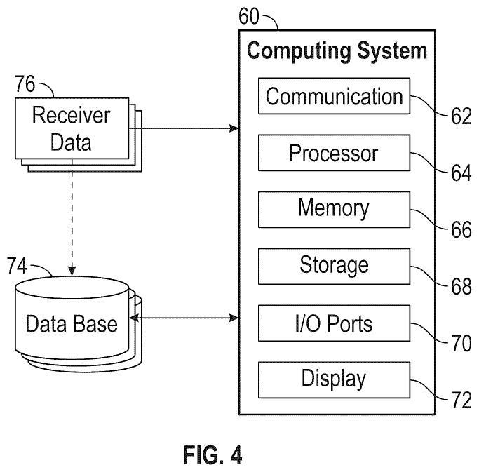

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location, and the properties of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the I/O ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. The processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, I/O modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location, and the properties of hydrocarbon deposits within the subsurface region 26, predictions of seismic properties associated with one or more wells in the subsurface region 26, and the like. The display 72 may be any suitable type of display, such as a liquid-crystal display (LCD), plasma display, or an organic light-emitting diode (LED) (or OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a 3D representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2D) seismic survey, the receiver locations may be placed along a single line, whereas in a 3D survey the receiver locations may be distributed across the surface in a grid pattern. As such, a 2D seismic survey may provide a cross sectional picture (vertical slice) of the Earth layers as they exist directly beneath the recording locations. A 3D seismic survey, on the other hand, may create a data “cube” or volume that may correspond to a 3D picture of the subsurface region 26.

In addition, a 4D (or time-lapse) seismic survey may include seismic data acquired during a 3D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

As described above, seismic surveys probe features in the subsurface regions of the Earth using vibrational waves in order to collect information regarding the subsurface regions. The information collected from the reflected, refracted, converted, etc, seismic waves may be used to create subsurface models that include velocity models and seismic images, which may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

Seismic imaging usually includes a two-step process. First, a velocity model of the subsurface region is estimated. Then, seismic traces obtained from a seismic survey are combined with the estimated velocity model to generate an image of the subsurface structure using migration or imaging algorithms. As used herein, “migration” refers to a seismic data processing technique which shifts or relocates seismic reflections captured in the observed seismic data to or at least towards their true physical positions in the subsurface region to create an image. As used herein, “observed seismic data” refers to data that is captured by one or more seismic receivers as seismic signals reflected by the subsurface region and which are originally generated by one or more corresponding sources. In some applications, an iterative data-fitting process such as an acoustic, elastic, or multi-parameter full-waveform inversion (FWI) process may be applied to observed seismic data (e.g., seismic data collected using a seismic survey system such as survey systems 22 and 38) to form a velocity model therefrom. In some applications, instead of using an imaging algorithm, an image of the subsurface structures may be created directly from the velocity model (i.e. FWI-derived reflectivity (FDR)).

The elastic FWI process is an advanced geophysical technique used to image subsurface structures, providing high-resolution models of the Earth's interior. Unlike other seismic inversion methods, such as simpler acoustic FWI that focuses on estimating parameters like P-wave velocity, elastic FWI incorporates both compressional (P) and shear(S) waves in the modelling and inversion process. Elastic FWI uses a more accurate representation of the governing physics and hence, the elastic FWI approach enhances the resolution and accuracy of subsurface models, especially in complex geological settings where wave mode conversions perform a significant role.

The elastic FWI process is an optimization-based seismic imaging technique that attempts to iteratively minimize the difference (or misfit, residue) between observed seismic data and modeled seismic data generated from a subsurface model (e.g., FWI objective function). Unlike methods that use simplified seismic arrivals or travel times (e.g., travel-time inversion), elastic FWI uses the full range of seismic waveforms. This results in more detailed and accurate model of the subsurface. The process uses a model that incorporates all wave types, including both P-waves and S-waves, to capture the full complexity of wave propagation.

An elastic FWI process is different from acoustic FWI methods that only use P-waves for modeling seismic data. While the acoustic FWI process is sufficient for environments where shear waves do not significantly affect wave propagation (e.g., simple marine environments), elastic FWI may be used in land-based and geologically complex areas (e.g. complex marine settings such as sub-salt or sub-basalt) where both P-waves and S-waves may be important for accurate imaging and understanding of subsurface properties.

The process of elastic FWI begins with data acquisition, where seismic data is collected using arrays of receivers such as receivers 36, 44, and 46 in FIGS. 2 and 3. This data includes a mix of P-waves and S-waves. Next, an initial subsurface model is created, based on prior geological knowledge or simplified inversion techniques. Using this initial model, modeled seismic data is generated through forward modeling, which solves the equations of motion for elastic wave propagation.

The difference between the observed/recorded seismic data and modeled seismic data is then calculated using a misfit function such as the least squares norm, which measures how well the modeled seismic data matches the recorded seismic data. The goal is to iteratively refine the subsurface model by minimizing this misfit through optimization algorithms, for example, using gradient-based methods. The model parameters, including P-wave and S-wave velocities and density, may be adjusted at each step to reduce the misfit between recoded seismic data and the modeled seismic data. The above process is repeated iteratively until the misfit reaches an acceptable level (e.g., a threshold level), resulting in a final subsurface model that provides high-resolution estimates of the geological parameters. These parameters may include P-wave and S-wave velocities, density, and other relevant elastic parameters, all of which may contribute to a detailed image of the subsurface that is crucial for geological interpretation and exploration.

Elastic FWI process is computationally intensive, especially for large-scale, production-level seismic datasets. Herein, “production-level seismic datasets” refer to large, high-volume collections of seismic data acquired during extensive surveys, and may be used for practical applications such as geophysical exploration, oil and gas reservoir analysis, or subsurface investigations. These datasets may be characterized based on size, often consisting of tens of millions of seismic traces collected over vast areas, and use significant computational resources to process. In the context of elastic FWI, production-level datasets may be used for generating detailed subsurface models, and FWI algorithms are tasked with optimizing the subsurface model in such a way that the overall misfit (often measured using L2 or L1 norms) between the observed seismic data and modeled seismic data is minimized for the entire dataset simultaneously.

However, in some cases, it may be advantageous to look into a specific region of the subsurface model rather than the entire volume. For instance, a geophysical study may focus on a particular feature such as a sediment-salt interface, which may be of critical interest due to geological importance or potential impact on hydrocarbon reservoirs. In these situations, the standard elastic FWI process may be sub-optimal. For instance, the standard elastic FWI process may be used to minimize the difference between the observed and modeled data everywhere in the model simultaneously. Therefore, the zone of interest comprises only a small part of the overall minimization goal and hence it may only be updated by a small amount with each iteration, or may not be usefully updated at all.

The challenge with the elastic FWI approach is that the elastic FWI approach may seek a global solution for the entire model and may not provide a way to focus the inversion efforts on the desired specific regions of interest. In other words, FWI may treat all parts of the model equally, even though in practice, some areas, such as the sediment-salt interface, are of greater interest to the user.

The present disclosure solves the aforementioned technical problem by providing a method to focus the inversion efforts on specific regions of interest within the subsurface model. In an embodiment, first an initial density model is selected. Then a perturbation is added near the zone of interest. This step is followed by performing forward modelling using both the density models, one with the perturbation and one without the perturbation. The difference between those two modeled datasets from the forward modeling may be used to compute a weighting function that highlights or differentiates the areas of observed data relevant to the zone of interest. Finally, the elastic FWI objective function may be adjusted to minimize the weighted difference between the observed seismic and the modeled seismic data, rather than the pure difference, focusing the elastic FWI process on the region of interest.

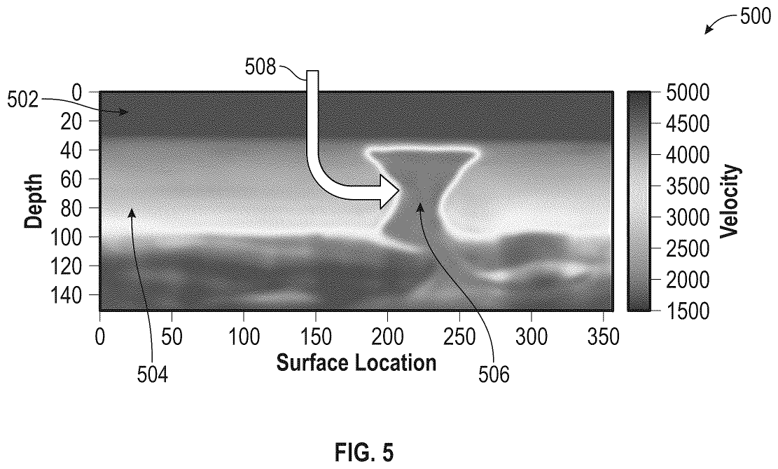

Referring now to FIG. 5, shown is a velocity model 500 of a subsurface region. In FIG. 5, a layer 502 represents the water layer, a layer 504 represents a sedimentary layer, and a layer 506 represents a salt layer. Further, as shown in FIG. 5, a part of the salt layer 506 is located in the sedimentary layer 504 and therefore, generates a sediment-salt interface 508. In many geological settings, such as in offshore basins or areas with ancient evaporite deposits, salt deposits may be found beneath layers of sediment. The sediment-salt interface 508 marks the transition from the porous and less dense sediment layers 504 to the highly impermeable and ductile salt layers 506. This sediment-salt interface 508 is significant in terms of hydrocarbon traps as salt acts as an impermeable seal, trapping hydrocarbons in the overlying sedimentary layers 504. The sediment-salt interface 508 is thus often a key location for oil and gas exploration and may define the boundaries of petroleum reservoirs. Furthermore, the sediment-salt interface 508 may be used for accurate imaging of the sediment layers underneath. Therefore, accurate imaging of this zone (i.e., sediment-salt interface 508) is of great importance for sub-salt image quality.

As shown in FIG. 5, the velocity model 500 used for forward modeling in seismic imaging represents the initial estimation of the subsurface's seismic velocity structure. Herein, the forward modeling may represent the process of simulating seismic wave propagation, based on a predefined subsurface model and including reflections, refractions, and scattering, through the earth. The result of the forward modeling may provide modeled seismic data. The velocity model 500 is an input of the forward modeling process. The velocity model 500 provides a first approximation of the seismic velocities (such as P-wave and S-wave velocities) at various depths and locations within the subsurface. For forward modeling, the velocity model 500 may be reasonably accurate from a kinematic point of view to reflect the expected arrival times of seismic waves at different receiver locations.

The velocity values at different depths may be selected based on prior geological knowledge or initial estimates from well logs, regional surveys, rough geological assumptions, or a prior acoustic FWI process to obtain kinematically accurate velocity model. The velocity model 500 may ideally capture the general structure of the subsurface, including major layers like sediments, rock formations, faults, or other significant geological features.

As shown in FIG. 5, the velocity model 500 may include layers such as layers 502, 504, and/or 506, in which each layer may have a uniform velocity and/or may include more complex features such as gradients or discontinuities to better approximate the actual subsurface. The kinematic accuracy of the velocity model 500 is important for the forward modeling process to produce modeled data that may then be compared to the recorded seismic data in order to produce the mask and guide further adjustments and refinements in the velocity model 500 through inversion processes such as elastic FWI.

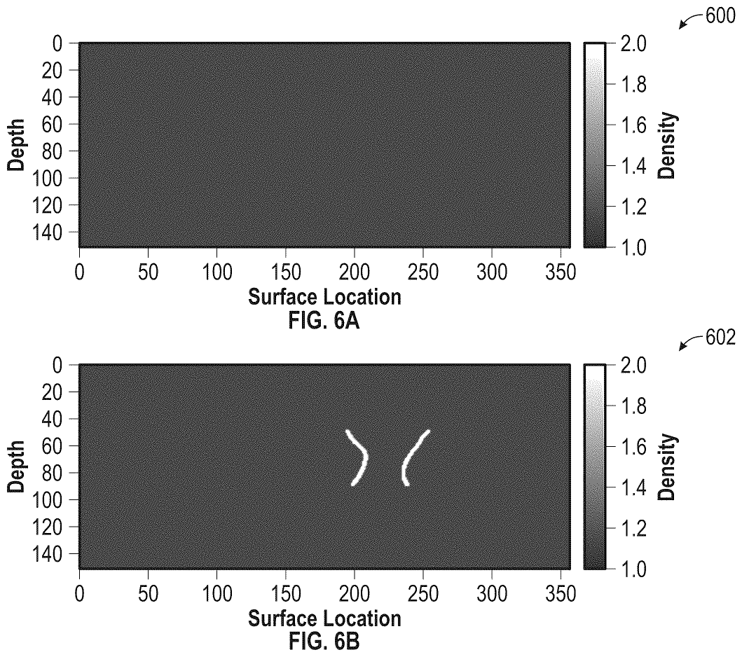

Referring now to FIGS. 6A and 6B, shown are density models 600 and 602 of a subsurface region. Specifically, FIG. 6A illustrates a density model 600 and FIG. 6B illustrates a density model 602 with added density contrast.

A density model is a representation of the spatial distribution of material density in the subsurface and is used for simulating the propagation of seismic waves through different geological layers. Density, defined as mass per unit volume, plays a key role in the behavior of seismic waves, influencing the strength of reflections and the degree of attenuation as waves travel through different subsurface materials. The density model defines how density values vary with depth and across geological layers such as sediments, rocks, and fluids, each of which has distinct density characteristics. The contrast in density between these layers contributes significantly to seismic impedance, which in turn affects the reflection and refraction of seismic waves at the interfaces such as the sediment-salt interface 508 shown in FIG. 5.

In seismic wave propagation, while the primary control over wave velocity is the material's elastic properties (e.g., P-wave and S-wave velocities), density influences the amplitude of seismic reflections and the seismic wave's ability to penetrate subsurface materials. For instance, a higher-density material tends to produce stronger seismic reflections, while a lower-density material allows seismic waves to travel through the lower-density material with less resistance. These density contrasts at subsurface boundaries such as the sediment-salt interface 508 shown in FIG. 5 may be used for seismic imaging, as the density contrasts may highlight changes in the geological structure and to interpret subsurface features.

In forward modeling, the density model, in combination with velocity model may be used to generate modeled seismic data that simulates the way the seismic waves interact with the subsurface. This modeled seismic data is then compared to recorded seismic data to assess the accuracy of the subsurface model and refine the geological interpretation. Further by incorporating density contrasts into the density model, the forward modeling may simulate realistic seismic responses, providing valuable insights into subsurface compositions and geological features such as faults, salt domes, and reservoir boundaries. Thus, the density model may be considered a critical component in forward modeling, contributing to the accurate simulation of seismic data and improving the interpretation of subsurface geology.

Turning first to FIG. 6A, shown is a density model 600 of the subsurface region. In FIG. 6A, the density value of the entire subsurface region may be considered uniform and may have a value of 1 kg/m³, and therefore, the color of the density model 600 is uniformly black because of the uniform density (of 1 kg/m³) across the represented subsurface region. Turning second to FIG. 6B, shown is a density model 602 of the subsurface region. In FIG. 6B, the density value of the entire subsurface region is considered uniform except for the interfaces corresponding to the sediment-salt interface 508 shown in FIG. 5. In an embodiment, the entire subsurface region except for the interfaces corresponding to the sediment-salt interface 508 shown in FIG. 5 may have a uniform density value of 1 kg/m³ and the interfaces corresponding to the sediment-salt interface 508 shown in FIG. 5 may have a density value of 2 kg/m³. Therefore, as shown in FIG. 6B, the color of the density model 602 is uniformly black because of uniform density (of 1 kg/m³) across the subsurface region except for the regions/zones corresponding to the sediment-salt interface 508 shown in FIG. 5. Further, as shown in FIG. 6B, the regions/zones corresponding to the sediment-salt interface 508 shown in FIG. 5 is represented in white lines because of the higher density values (of 2 kg/m³) compared to the rest of the subsurface region. Comparing both density models 600 and 602 shown in FIGS. 6A and 6B, the interfaces corresponding to the sediment-salt interface 508 shown in FIG. 5 may have a higher density value while the other regions or the background region may have a uniform lower density value. It may be understood that the density model 602 shown in FIG. 6B may be synthetic, and by inserting the density contrast, a synthetic seismic reflection may be created in modeled data which may be used to create a mask and highlight similar events in the recorded seismic data during the process of FWI.

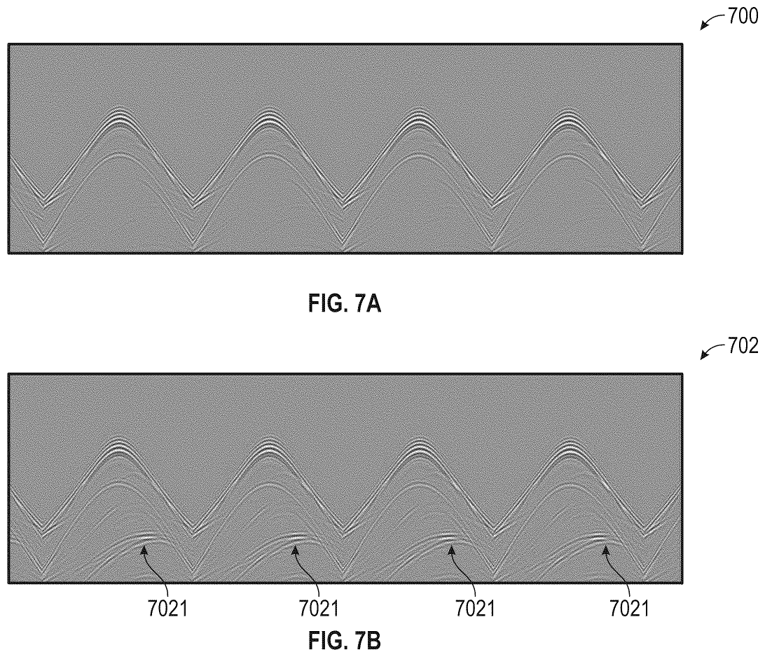

FIGS. 7A-7C show modeled seismic data of the subsurface region. Specifically, FIG. 7A illustrates modeled seismic data 700, FIG. 7B illustrates modeled seismic data 702, and FIG. 7C illustrates data difference 704 between modeled seismic data 700 and modeled seismic data 702.

Turning first to FIG. 7A, shown is the modeled seismic data 700 that is obtained based on the velocity model 500 shown in FIG. 5 and the density model 600 shown in FIG. 6A. In an embodiment, performing forward modeling using the velocity model 500 and the density model 600 to obtain modeled seismic data 700 may involve simulating the propagation of seismic waves through a subsurface model to generate synthetic seismic responses. These synthetic seismic responses represent how seismic waves would interact with the geological layers defined by the velocity model 500 and the density model 600, capturing reflections, refractions, and other wave behaviors. As specified before, the velocity model 500 and the density model 600 describe the physical properties of the subsurface, with the velocity model 500 specifying the speed at which seismic waves travel through different layers, and the density model 600 defining the mass per unit volume of the materials in those different layers. Together, the velocity model 500 and the density model 600 provide the necessary information to simulate how seismic waves will behave as they propagate through the Earth, interact with different layers, and return to the surface.

As previously specified in FIG. 5, the velocity model 500 defines the seismic velocities of the subsurface materials, including both P-wave (or compressional) velocity (Vp) and S-wave (or shear) velocity (Vs). These velocities may dictate the speed at which seismic waves move through the subsurface. The velocity model 500 may be one-dimensional (vertical layers), two-dimensional (cross-sectional profiles), or 3D (volumetric representation), depending on the scale and complexity of the survey area. Both the velocity and density contrast between different layers, such as between sediments and salt layers (e.g., the sediment-salt interface 508 shown in FIG. 5), are important for determining how seismic waves will be refracted, reflected, or transmitted at layer boundaries.

As previously specified in FIG. 6A, the density model 600 used in this subsurface model specifies the mass per unit volume of the subsurface materials, which is used in evaluating wave reflection and impedance contrasts. When seismic waves encounter a boundary between layers with differing densities such as the sediment-salt interface 508 shown in FIG. 5, a portion of the seismic wave is reflected, and the remainder is transmitted through the interface. The density contrast between layers (in combination with velocity contrast) contributes to the overall seismic impedance, which may control the amplitude and strength of seismic reflections. The term “density contrast” refers to the change in density at a location in the subsurface, while the term “velocity contrast” refers to a change in velocity at a location in the subsurface.

Using both the velocity model 500 and the density model 600, forward modeling simulates propagation of seismic waves through the subsurface. The seismic wave equations are solved, under consideration of the properties of the materials at each depth or location in the subsurface model. As seismic waves propagate, the seismic waves interact with geological features such as interfaces, faults, and varying material properties. These interactions cause the seismic waves to reflect, refract, scatter, and convert, with the resulting seismic response captured in synthetic seismic traces. The synthetic traces represent the expected seismic signals, including travel times, amplitudes, and frequencies, that would be recorded by receivers placed on the surface.

The output of forward modeling the seismic waves based on the velocity model 500 and the density model 600 is the modeled seismic data 700, which consists of synthetic seismic traces that simulate the expected seismic response of the subsurface model. These traces may essentially predict how the seismic waves may behave given the velocity model 500 and the density model 600.

Turning now to FIG. 7B, shown is the modeled seismic data 702 that is obtained based on the velocity model 500 shown in FIG. 5 and the density model 602 shown in FIG. 6B. The difference between the modeled seismic data 700 shown in FIG. 7A and the modeled seismic data 702 shown in FIG. 7B is that the modeled seismic data 702 may have additional modeled seismic data corresponding to the density contrast present in the density model 602. In an embodiment, performing forward modeling using the velocity model 500 and the density model 602 to obtain the modeled seismic data 702 may involve simulating the propagation of seismic waves through a subsurface model to generate synthetic seismic responses. The velocity model 500 and the density model 602 describe the physical properties of the subsurface, with the velocity model 500 specifying the speed at which seismic waves travel through different layers, and the density model 602 defining the mass per unit volume of the materials in those different layers. Together, the velocity model 500 and the density model 602 may provide the necessary information to simulate how seismic waves will behave as they propagate through the Earth, interact with different layers, and return to the surface.

As specified previously, the density model 602 shown in FIG. 6B is different from the density model 600 shown in FIG. 6A. The two density models differ at the locations where the model updates of the proposed modified FWI algorithm are focused. In the example here those contrasts correspond to the sediment-salt interface 508 shown in FIG. 5. The addition of density contrast may increase the density value at the locations corresponding to the sediment-salt interface 508 shown in FIG. 5 compared to the remaining surrounding subsurface area. In an embodiment, the density model 602 shown in FIG. 6B may be obtained from the density model 600 shown in FIG. 6A by increasing the density values at the locations corresponding to the sediment-salt interface 508 shown in FIG. 5 compared to the rest of the areas in the subsurface. For instance, as shown in FIG. 6B, the locations corresponding to the sediment-salt interface 508 shown in FIG. 5 may have a density value of 2 kg/m³, which may be represented in white, while the rest of the area in the subsurface may have a density value of 1 kg/m³, which may represent in black.

As previously specified in FIG. 6B, the density model 602 used in this subsurface model specifies the mass per unit volume of the subsurface materials, which is used to evaluate wave reflection and impedance contrasts. When seismic waves encounter a boundary between layers with differing densities such as the sediment-salt interface 508 shown in FIG. 5, a portion of the seismic wave is reflected, and the remainder is transmitted through the interface. The density contrast between layers (in combination with velocity contrast) contributes to the overall seismic impedance, which may control the amplitude and strength of seismic reflections.

Using both the velocity model 500 and the density model 602, forward modeling simulates propagation of seismic waves through the subsurface and specifically in the locations corresponding to the sediment-salt interface 508 shown in FIG. 5. The seismic wave equations are solved, under consideration of the properties of the materials at each depth or location in the subsurface model. As seismic waves propagate, the seismic waves interact with geological features such as interfaces, faults, and varying material properties. These interactions cause the seismic waves to reflect, refract, scatter, and convert, with the resulting seismic response captured in synthetic seismic traces. The synthetic traces represent the expected seismic signals, including travel times, amplitudes, and frequencies, that would be recorded by receivers placed on the surface.

The output of forward modeling the seismic waves based on the velocity model 500 and the density model 602 is the modeled seismic data 702, which consists of synthetic seismic traces that simulate the expected seismic response of the subsurface model. These synthetic seismic responses represent how seismic waves would interact with the geological layers defined by the velocity and density models, capturing reflections, refractions, and other wave behaviors. These traces may essentially predict how the seismic waves may behave given the velocity model 500 and the density model 602. Compared to the modeled seismic data 700, the modeled seismic data 702 additionally includes modeled seismic data 7021 corresponding to the sediment-salt interface 508 shown in FIG. 5. These additional modeled seismic data 7021 may be generated because of the density contrast present at the density model 602 specifically at the locations corresponding to the sediment-salt interface 508 shown in FIG. 5.

Turning now to FIG. 7C, shown is the data difference 704 between modeled seismic data 700 and modeled seismic data 702. Herein, the data difference 704 may represent the modeled data corresponding to the density contrast. For instance, by comparing the synthetic seismic responses generated from both models, it may be possible to assess the impact of the adjustments made in the density model 602. The modeled seismic data 700, derived from the density model 600 and the velocity model 500, serves as a baseline, while the modeled seismic data 702, constructed incorporating perturbations at and around specific subsurface zones of interest, is changed where the changes at those zones of interest produced corresponding changes in the modeled seismic data, e.g. the events 7021 in the seismic data 702. The data difference 704 may be calculated by subtracting the modeled seismic data 700 from the modeled seismic data 702. The data difference 704 may highlight the locations of events 7021 that correspond to the additional density contrast in the density model 602. Therefore, the locations of these events in the data domain may be identified and then used to highlight or weight up the contribution of events from these locations during the inversion process. A weighting function may be generated based on the obtained data difference 704. The weighting function is a mathematical tool that may be used to assign different levels of importance to various components of data during the elastic FWI process. The weighting function may adjust the influence of different data points, allowing the subsurface model to focus more on areas with larger differences or errors. By emphasizing regions with significant discrepancies, the weighting function may guide the inversion or optimization process, improving the accuracy of the subsurface model. This ensures that the subsurface model may be refined at the zones of interest, leading to a more accurate representation of the subsurface. There are many methods as specified below that may be used to convert the data difference 704 into the weighting function. The generated weighting function may be used to modify the recorded seismic data and may be used along with the modeled seismic data to focus elastic FWI processing to a zone or region of interest in the subsurface model, such as the locations corresponding to the sediment-salt interface 508 shown in FIG. 5, to obtain an accurate subsurface model.

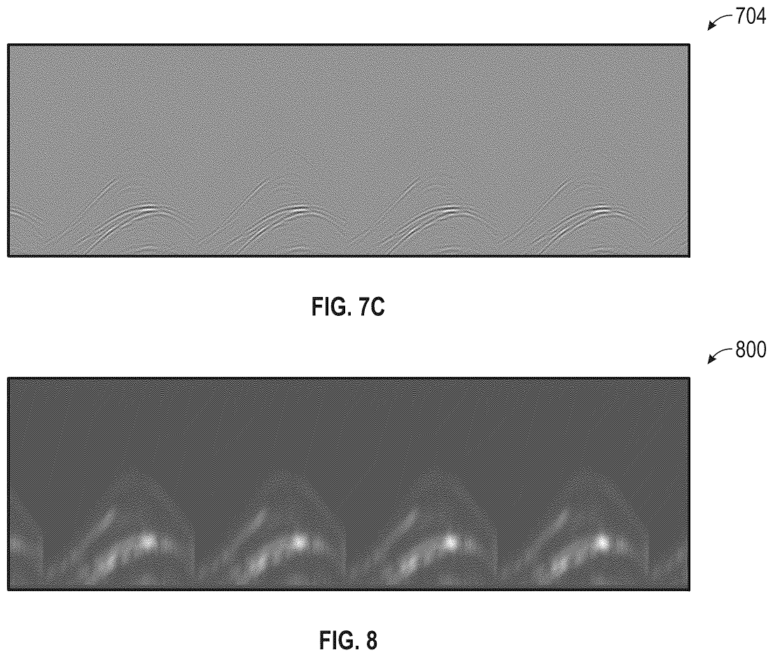

Referring now to FIG. 8, shown is an envelope 800 of the data difference 704 shown in FIG. 7C. An envelope refers to a curve or boundary that encapsulates or defines the outer limits of a dataset or a signal, often representing overall amplitude or extent of the dataset or the signal. Specifically, the envelope 800 in FIG. 8 is a graphical representation of the maximum variation or the “outer bounds” of the data difference 704 shown in FIG. 7C. The envelope 800 may smooth out fluctuations or noise, providing a clearer view of the underlying trends or significant features within the data difference 704. The envelope 800 may also be referred to as a “mask” because the envelope 800 may be used to focus attention on certain portions of the recorded seismic data, effectively masking or highlighting areas of interest for elastic FWI processing. The envelope 800 may be used to generate the weighting function specified previously. The envelope 800 may be generated from the data difference 704 using various different methods, which is not limited herein. In an embodiment, the envelope 800 may be generated based on the data difference 704 and using the Hilbert transform. With the Hilbert transform, an analytical signal of the data difference 704 may be obtained by combining the data difference 704 and a 90-degree phase-shifted version of the data difference 704. Then the envelope 800 may be obtained by calculating the magnitude or the absolute value of the analytic signal.

In another embodiment, the envelope 800 may be generated based on the data difference 704 and using a rectification process. During the rectification process, the negative parts of the data difference 704 may be removed and may make all values of the data difference 704 be positive. Removing the negative parts of the data difference 704 may be done through two techniques: half-wave rectification, where the positive values are retained and negative values are set to zero; and/or full-wave rectification, where negative values are converted to positive by taking the absolute value of the data difference 704. After the rectification process, the rectified data difference 704 may be passed through a smoothing filter, such as a low-pass filter, to reduce high-frequency oscillations and produce the envelope 800.

In another embodiment, the envelope 800 may be generated based on the data difference 704 and using a Hilbert-Huang Transform (HHT) process. The HHT process may be used specifically when the data difference 704 may have non-stationary and nonlinear characteristics. During the HHT process, the data difference 704 may be decomposed into intrinsic mode functions (IMFs) using Empirical Mode Decomposition (EMD), and then the Hilbert transform may be applied to each IMF to extract the corresponding instantaneous frequency and amplitude. Finally, the envelope 800 may be obtained from the instantaneous amplitude.

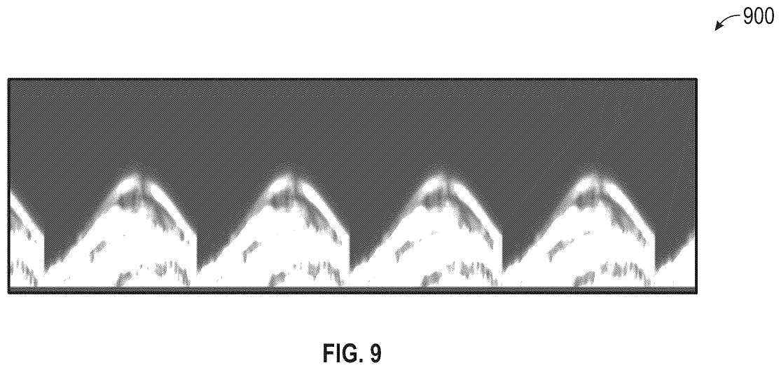

Referring now to FIG. 9, shown is another envelope 900 of the data difference 704 shown in FIG. 7C. The difference between the envelope 800 shown in FIG. 8 and the envelope 900 shown in FIG. 9 is that the envelope 900 may be further processed by applying thresholding, normalization, and scaling as necessary. In an embodiment, after obtaining the envelope 800, to process the envelope 800 with thresholding, normalization, and scaling in sequence, the first step may be to apply thresholding, which filters out or reduces small values of the envelope 800 by comparing each point to a predefined threshold. Next, normalization may be performed by scaling the remaining envelope 800 values to a specific range, for example [0, 1], ensuring uniformity and standardization across the envelope 800. Finally, scaling may be applied by multiplying the normalized envelope 800 by a scaling factor to adjust the magnitude to the desired level. This sequence of operations may allow for effective modification of the envelope 800 to be envelope 900 shown in FIG. 9, that may be suitable for further analysis, interpretation, or use in applications such as signal processing, feature extraction, or seismic data enhancement.

In an embodiment, the envelope 800 may be used when the interest is on the stronger reflections and the envelope 900 may be used when the interest is on enhancing overall model accuracy. Furthermore, after obtaining either the envelope 800 or the envelope 900, the high-energy regions that correspond to significant seismic features, such as strong reflections from geological interfaces like the sediment-salt interface 508 shown in FIG. 5 may be identified.

The identification process may be achieved through thresholding or other methods to locate peaks or regions in the envelope 800 or the envelope 900 where energy is significant. In an embodiment, the envelope's local maxima may be computed or a threshold may be applied to capture areas with energy exceeding a certain level. After identifying these regions, the envelope may be normalized to ensure the weighting function operates on a consistent scale, sometimes ranging from 0 to 1. Normalization prevents high-energy regions from disproportionately influencing the inversion result. A normalization technique may involve dividing the envelope by its maximum value, or using statistical methods such as mean or standard deviation to scale the values. The weighting function may be then derived from the normalized envelope by assigning higher weights to the high-energy regions and lower weights to areas with weak amplitudes, which may correspond to less relevant features or noise. In an embodiment, higher weights may be given to areas with significant reflections, such as sediment-salt interfaces, while lower weights may be assigned to regions with minimal energy. This may be done by directly using the envelope values as weights or applying functions like Gaussian or exponential scaling to emphasize certain regions.

After computing the weighting function, the weighting function may be integrated into the elastic FWI process by modifying the objective function or misfit function. Instead of minimizing the standard misfit between the recorded seismic data and the modeled seismic data, the elastic FWI process may minimize the weighted misfit, giving more influence to high-energy regions or the zone of interest of the subsurface region identified in the envelope. Therefore, this approach may allow the elastic FWI process to focus on the zones of interest of the subsurface region, improving the model's resolution in those zones.

In an embodiment, the above-mentioned process may be performed by changing the velocity model and keeping the density model constant. For example, the velocity model may be updated by adding a velocity contrast at the region of interest to generate a second velocity model. Herein, the subsurface model may be obtained using an accurate density model along with first, an initial velocity model and second, the second velocity model.

In another embodiment, the above-mentioned process may be performed by changing both the velocity model and the density model. For example, the velocity model may be updated by adding a velocity contrast at the region of interest to generate a second velocity model and the density model may be updated to add a density contrast at the region of interest to generate a second density model. Herein, the second subsurface model may be obtained using the second density model and the second velocity model.

We have described the method for the case where the elastic FWI employs a density and a P-wave velocity model, which updates the P-wave velocity model and the density model using recorded pressure data (for marine data) or vertical velocity (for land data). The S-wave velocity model may be fixed or alternatively may be calculated from the P-wave velocity model deterministically, using a method that calculates the S-wave velocities from the P-wave velocities and densities. Other FWI algorithms are also in common use, and this same inventive method may be applied to other varieties of FWI. Alternative formulations of elastic FWI may have a density, a P-wave velocity, and a separately specified S-wave velocity, with the FWI algorithm inverting for all three of these. Alternatively, the elastic FWI algorithm may invert for just P-wave velocity. Yet other alternative formulations of elastic FWI, multi-parameter FWI methods, may add one or more anisotropy and attenuation parameters in addition to density, P-wave velocity, and S-wave velocity, and may invert for any combination of these. Any or all of these may be perturbed to find the corresponding data weights. For example, the areas of interest could be highlighted by varying an attenuation or anisotropy parameter there, instead of the P-wave velocity or density. The areas of interest could be highlighted by varying the S-wave model, or some combination of any or all of the various components of the model. Yet other alternative formulations of elastic FWI may also simultaneously make use of two or more seismic data components, for example pressure, vertical velocity, two components of horizontal velocity, and rotational measurements. The data weights may be separately calculated for each of these distinct data components. The method also applies to acoustic FWI, where the wave equation being used only supports one wave type, pressure waves. The method also applies when alternative combinations of velocity, density, anisotropy, or attenuation parameters are used, for example instead of P-wave velocity and density as described here, the method could use P-wave velocity and impedance. In time-lapse FWI the algorithm operates on seismic datasets recorded at two or more different times, and solves for both a velocity field and the changes in that field between the two recording times. In that case the calculated data weights would be applied to both seismic datasets. In addition to a first model and a second perturbed model, from which weights to be applied to the seismic data may be calculated, a third, fourth, etc, perturbed model could also be created, with sets of data weights calculated from each of these. The additional sets of data weights could be combined together, or each used separately in additional inversion iterations. Those or ordinary skill in the art will readily see how to apply the inventive method to other varieties of FWI.

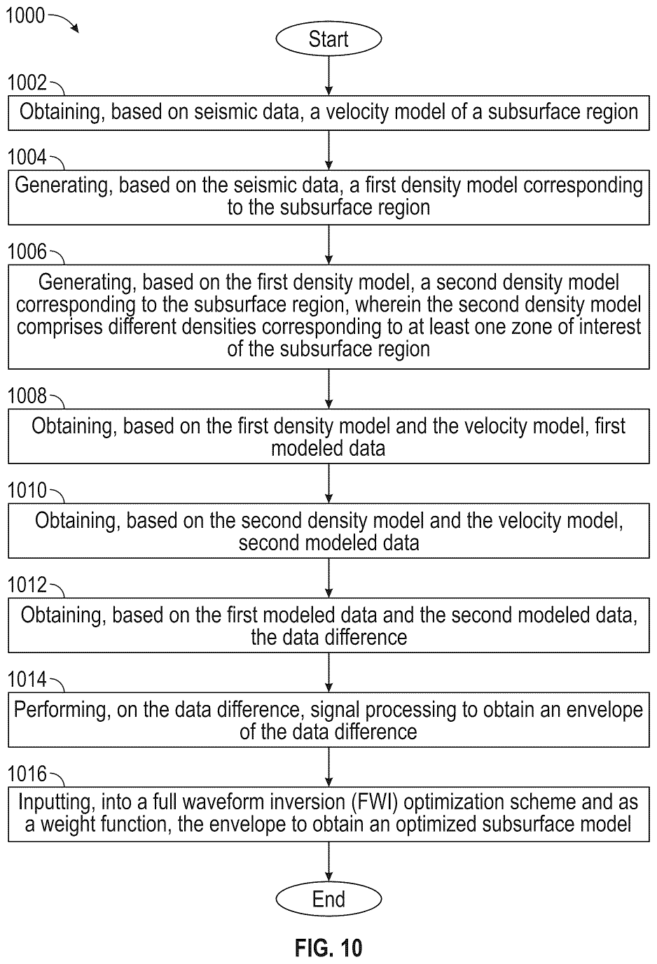

Referring now to FIG. 10, shown is a flowchart of an embodiment of a method of locally attentive FWI according to various embodiments described herein for the case of elastic FWI that is inverting a single data component for a single velocity field. At least some, if not all, of the steps of method 1000 shown in FIG. 10 may be executed by the computing system 60 shown in FIG. 4, although it may be understood that at least some of the steps of method 1000 may be executed by systems other than computing system 60. Additionally, it may be understood that the migration of seismic data described by method 1000 may be used for a variety of purposes, including volumetric analysis and in the planning hydrocarbon exploration, which would extend through the subsurface region. Thus, method 1000 may be used in the process of generating final seismic data including final migrated seismic data, which may include, for example, final migrated seismic gathers and/or one or more final stacked seismic images of the subsurface region.

Beginning at step 1002, method 1000 comprises obtaining, by the computing system 60 based on the seismic data, a velocity model of a subsurface region. In an embodiment, obtaining a velocity model of a subsurface region using a computing system involves processing seismic data to derive a velocity model that may accurately represent the seismic wave velocity within the Earth's subsurface. The process begins with data acquisition, where seismic data is collected through geophones or hydrophones that record seismic waves generated by a controlled source. This raw data is then pre-processed to remove noise and enhance signal quality, making it suitable for model construction. An initial velocity model is often generated based on geological knowledge or prior data, which serves as a starting point for further refinement.

Obtaining the velocity model, such as the velocity model 500, may involve applying an inversion algorithm, such as tomography or acoustic/elastic FWI, to iteratively update the subsurface model. The inversion process may minimize the misfit between the recorded seismic data and the modeled seismic data, adjusting the velocity distribution in the subsurface region. As the algorithm progresses, the velocity model is refined based on this iterative feedback, leading to a more accurate velocity model. The final model is then subject to post-processing and interpretation to assess the geological features of the subsurface, with the resulting velocity model aiding in seismic imaging, exploration, and reservoir characterization.

At step 1004, method 1000 comprises generating, by the computing system 60 based on the seismic data, a first density model corresponding to the subsurface region. In an embodiment, generating a first density model corresponding to the subsurface region based on the seismic data may involve using recorded seismic wave information to estimate the distribution of density within the Earth's subsurface. The process begins with the acquisition of the seismic data, which may provide travel times and amplitudes of seismic waves as they pass through various subsurface materials. This seismic data may then be pre-processed to remove noise and improve signal quality, making the seismic data suitable for model construction. An initial density model is often constructed using geological knowledge or well log data, which serves as a starting point for further refinement.

Generating the density model, such as the first density model 600, involves applying inversion techniques to estimate the density distribution based on the seismic data. Acoustic/elastic FWI may be used, where both velocity and density models are adjusted iteratively to minimize the misfit between the observed and modeled seismic responses. As the inversion progresses, the density model may be refined to more accurately reflect the subsurface composition.

At step 1006, method 1000 comprises generating, by the computing system 60 based on the first density model, a second density model corresponding to the subsurface region, in which the second density model comprises different densities corresponding to at least one zone of interest of the subsurface region. Generating the second density model, such as the second density model 602, corresponding to the subsurface region based on the first density model 600 may involve adding a density contrast to the first density model 600 to focus on specific areas of interest within the subsurface. As used herein, “adding density contrast” refers to increasing or decreasing the density values corresponding to the areas of interest within the subsurface compared to the rest of the area of the subsurface. As specified before, the first density model 600 may have uniform density (of 1 kg/m³) across the subsurface region and the second density model 602 may have some areas with higher density values (of 2 kg/m³) to highlight the areas of interest within the subsurface compared to the rest of the area of the subsurface. The first density model, derived from seismic data, may provide a broad representation of the subsurface's overall density distribution or the background density. Using the first density model as a starting point, the second density model is created by incorporating density contrast that may highlight the zones of interest, such as specific geological interfaces or potential reservoir areas.

At step 1008, method 1000 involves obtaining, by the computing system 60 based on the first density model and the velocity model, first modeled data. In an embodiment, obtaining first modeled data, such as the first modeled data 700 based on the first density model 600 and the velocity model 500, may involve using forward modeling techniques to simulate the seismic response of the subsurface region. Forward modeling is a process in which a mathematical model, constructed using the first density and velocity models, may be used to predict the seismic data that would be recorded by seismic receivers based on a set of input parameters. The velocity model provides information about the propagation speed of seismic waves, while the first density model describes how the subsurface materials affect the wave's amplitude. By combining these two models, the forward modeling process generates first modeled seismic data that mimics the behavior of seismic waves as they travel through different subsurface layers.

At step 1010, method 1000 involves obtaining, by the computing system 60 based on the second density model and the velocity model, second modeled data. In an embodiment, obtaining second modeled data, such as the second modeled data 702 based on the second density model 602 and the velocity model 500, may involve using the forward modeling techniques to simulate seismic wave propagation through the subsurface region, incorporating the second density model alongside the velocity model. The second density model differs from the first density model at or around areas of interest. By applying forward modeling, the seismic wave behavior is simulated through the subsurface using both the second density and the velocity models. This process produces a second modeled seismic data 702 that differs from the first modeled seismic data 700 wherever the energy traveling from source to receiver has interacted with the one or more areas of interest.

At step 1012, the method 1000 comprises obtaining, by the computing system 60 based on the first modeled data and the second modeled data, the data difference. In an embodiment, obtaining the data difference, such as the data difference 704 based on the first modeled data 700 and the second modeled data 702 may involve comparing the synthetic seismic responses generated from both models to assess the impact of the adjustments made in the second density model. The first modeled data, derived from the first density and velocity models, serves as a baseline, while the second modeled data, incorporating perturbations for specific subsurface zones of interest, represents a simulation of the seismic wave propagation that highlights the one or more zones of interest. The data difference may be calculated by subtracting the first modeled data from the second modeled data, highlighting the changes in the seismic response due to the updates in the second density model.

Referring to FIG. 10, the step 1014 in method 1000 includes performing, by the computing system 60 on the data difference, signal processing to obtain an envelope of the data difference. In an embodiment, performing signal processing on the data difference to obtain the envelope, such as the envelope 800 or the envelope 900, may involve applying techniques that capture the amplitude variations of the seismic signal, which highlight significant features such as reflections or interfaces in the subsurface. In an embodiment, the Hilbert transform may be applied, which creates an analytic signal by combining the data difference with a 90-degree phase-shifted version of the data difference, and then calculating the magnitude of this analytic signal to obtain the envelope. Alternatively, a rectification process may be applied, where the negative values of the data difference are converted to positive, followed by smoothing or filtering to extract the amplitude envelope. Another advanced method is the Hilbert-Huang Transform (HHT), which may decompose the data difference into intrinsic mode functions (IMFs) and may then calculate the envelope by summing the absolute value of the IMFs, providing a more adaptive and localized representation of the signal's amplitude. These envelope extraction methods may be used to focus on the primary seismic features and to emphasize regions of interest for further analysis and model refinement.

Finally, at step 1016, the method 1000 comprises inputting, by the computing system 60 into an FWI optimization scheme and as a weight function, the envelope to obtain an optimized subsurface model. In an embodiment, the envelope, which highlights key seismic features and variations in amplitude, may serve to prioritize certain regions of the subsurface model during the inversion process. By using the envelope as a weight function, the FWI optimization adjusts the subsurface model iteratively, giving more emphasis to the data corresponding to the areas of the model with higher weights. This allows the inversion process to focus on improving the model's accuracy in regions of interest (introduced as a contrast in the density model 602 shown in FIG. 6B), while reducing the influence of less critical areas, ultimately producing a more refined and optimized subsurface model that better matches the observed seismic data in the zone of interest while using computing resources far more efficiently.

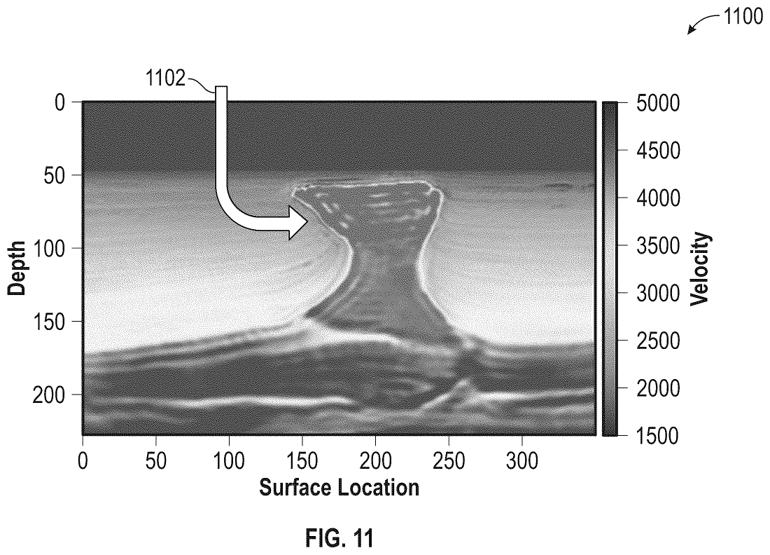

Referring now to FIG. 11, shown is a velocity model 1100 of a subsurface region. The velocity model 1100 is obtained after performing the method 1000 of locally attentive FWI process. As shown in FIG. 11, a sediment-salt interface 1102 compared to the sediment-salt interface 508 shown in FIG. 5 may have a more accurately defined edges around the zone of interest at the sediment-salt interface 1102 due to improved resolution or model refinement. This enhanced accuracy may be the result of applying techniques such as elastic FWI with a focused weight function, where the inversion process places greater emphasis on regions of interest highlighted by the density model 602 shown in FIG. 6B. By refining the velocity and density models with greater attention to these critical interfaces, the updated model (as can be seen from the sediment-salt interface 1102) may exhibit more precise delineation of the sediment-salt boundary, reducing uncertainties and producing a sharper, more defined edge. This results in a more accurate representation of subsurface features, which is particularly important for applications such as reservoir characterization, geological interpretation, and resource exploration.

In an embodiment, the method 1000 may further include obtaining, based on seismic data, a velocity model of a subsurface region; generating, based on the seismic data, a first density model corresponding to the subsurface region; generating, based on the first density model, a second density model corresponding to the subsurface region, wherein the second density model comprises different densities corresponding to at least one zone of interest of the subsurface region; obtaining, based on the first density model and the velocity model, first modeled data; obtaining, based on the second density model and the velocity model, second modeled data; obtaining, based on the first modeled data and the second modeled data, the data difference; performing, on the data difference, signal processing to obtain an envelope of the data difference; and inputting, into an FWI optimization scheme and as a weight function, the envelope to obtain an optimized subsurface model. In another embodiment, the method 1000 may further include performing the signal processing to obtain the envelope comprises performing, on the data difference, a Hilbert transform to obtain the envelope and may further include before inputting the envelope, performing thresholding, normalization, and scaling on the envelope. In an embodiment, the method 1000 may further include performing, on the data difference, a rectification process to obtain an absolute value of the data difference; and performing, on the absolute value of the data difference, a low-pass filtering to obtain the envelope. In an embodiment, the method 1000 may further include, before inputting the envelope, performing thresholding, normalization, and scaling on the envelope. In an embodiment, the method 1000 may further include setting an initial density model corresponding to the subsurface region as the first density model; and inserting, into the first density model and to areas corresponding to the at least one zone of interest, density contrast to obtain the second density model. Furthermore, the FWI optimization scheme comprises at least one of a first elastic FWI optimization scheme comprising a density, a P-wave velocity, and an S-wave velocity; a second elastic FWI optimization scheme comprising the P-wave velocity and an impedance; a third elastic FWI optimization scheme comprising the P-wave velocity and the density; a first multi-parameter FWI optimization scheme comprising the density, the P-wave velocity, the S-wave velocity, and one or more an anisotropy parameter or an attenuation parameter; a second multi-parameter FWI optimization scheme comprising two or more components of the density, the P-wave velocity, the S-wave velocity, and one or more the anisotropy parameter or the attenuation parameter; or an acoustic FWI optimization scheme comprising the P-wave velocity.

In an embodiment, the method 1000 may further include performing, on an initial velocity model, an FWI optimization scheme to obtain the velocity model.

In an embodiment, the method 1000 may further include subtracting the first modeled data from the second modeled data to obtain the data difference.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method comprising:
obtaining, based on seismic data, a velocity model of a subsurface region;
generating, based on the seismic data, a first density model corresponding to the subsurface region;
generating, based on the first density model, a second density model corresponding to the subsurface region, wherein the second density model comprises different densities corresponding to at least one zone of interest of the subsurface region;
obtaining, based on the first density model and the velocity model, first modeled data;
obtaining, based on the second density model and the velocity model, second modeled data;
obtaining, based on the first modeled data and the second modeled data, a data difference, wherein the data difference comprises additional modeled data corresponding to the different densities in the second density model;
performing, on the data difference, signal processing to obtain an envelope of the data difference; and
inputting, into a full-waveform inversion (FWI) optimization scheme and as a weight function, the envelope to obtain an optimized subsurface model.

2. The method of claim 1, further comprising:
performing, on the data difference, a Hilbert transform to obtain the envelope; and
performing thresholding, normalization, and scaling on the envelope before inputting the envelope.

3. The method of claim 2, wherein the FWI optimization scheme comprises at least one of:
a first elastic FWI optimization scheme comprising a density, a P-wave velocity, and an S-wave velocity;
a second elastic FWI optimization scheme comprising the P-wave velocity and an impedance;
a third elastic FWI optimization scheme comprising the P-wave velocity and the density;
a first multi-parameter FWI optimization scheme comprising the density, the P-wave velocity, the S-wave velocity, and one or more an anisotropy parameter or an attenuation parameter;
a second multi-parameter FWI optimization scheme comprising two or more components of the density, the P-wave velocity, the S-wave velocity, and one or more the anisotropy parameter or the attenuation parameter; or
an acoustic FWI optimization scheme comprising the P-wave velocity.

4. The method of claim 1, wherein performing the signal processing to obtain the envelope comprises:
performing, on the data difference, a rectification process to obtain an absolute value of the data difference; and
performing, on the absolute value of the data difference, a low-pass filtering to obtain the envelope.

5. The method of claim 4, wherein before inputting the envelope, the method further comprises performing thresholding, normalization, and scaling on the envelope.

6. The method of claim 1, wherein generating the first density model comprises setting an initial density model corresponding to the subsurface region as the first density model.

7. The method of claim 6, wherein generating the second density model comprises inserting, into the first density model and to areas corresponding to the at least one zone of interest, density contrast to obtain the second density model.

8. The method of claim 1, wherein obtaining the velocity model comprises performing, on an initial velocity model, an FWI optimization scheme to obtain the velocity model.

9. The method of claim 1, wherein obtaining the data difference comprises subtracting the first modeled data from the second modeled data to obtain the data difference.

10. A computing system comprising:
a memory configured to store instructions; and
one or more processors coupled to the memory and configured to execute the instructions to cause the computing system to:
obtain, based on seismic data, a velocity model of a subsurface region;
generate, based on the seismic data, a first density model corresponding to the subsurface region;
generate, based on the first density model, a second density model corresponding to the subsurface region, wherein the second density model comprises different densities corresponding to at least one zone of interest of the subsurface region;
obtain, based on the first density model and the velocity model, first modeled data;
obtain, based on the second density model and the velocity model, second modeled data;
obtain, based on the first modeled data and the second modeled data, data difference, wherein the data difference comprises additional modeled data corresponding to the different densities in the second density model;
perform, on the data difference, signal processing to obtain an envelope of the data difference; and
input, into a full waveform inversion (FWI) optimization scheme and as a weight function, the envelope to obtain an optimized subsurface model.

11. The computing system of claim 10, wherein the one or more processors are further configured to execute the instructions to cause the computing system to:
perform, on the data difference, a Hilbert transform to obtain the envelope; and
perform thresholding, normalization, and scaling on the envelope before inputting the envelope.

12. The computing system of claim 11, wherein the FWI optimization scheme comprises at least one of:
a first elastic FWI optimization scheme comprising a density, a P-wave velocity, and an S-wave velocity;
a second elastic FWI optimization scheme comprising the P-wave velocity and an impedance;
a third elastic FWI optimization scheme comprising the P-wave velocity and the density;
a first multi-parameter FWI optimization scheme comprising the density, the P-wave velocity, the S-wave velocity, and one or more an anisotropy parameter or an attenuation parameter;
a second multi-parameter FWI optimization scheme comprising two or more components of the density, the P-wave velocity, the S-wave velocity, and one or more the anisotropy parameter or the attenuation parameter; or
an acoustic FWI optimization scheme comprising the P-wave velocity.

13. The computing system of claim 10, wherein the one or more processors are further configured to execute the instructions to cause the computing system to:
perform, on the data difference, a rectification process to obtain an absolute value of the data difference; and
perform, on the absolute value of the data difference, a low-pass filtering to obtain the envelope.

14. The computing system of claim 13, wherein before inputting the envelope, the one or more processors are further configured to execute the instructions to cause the computing system to perform thresholding, normalization, and scaling on the envelope.

15. The computing system of claim 10, wherein the one or more processors are further configured to execute the instructions to cause the computing system to set an initial density model corresponding to the subsurface region as the first density model.

16. The computing system of claim 15, wherein the one or more processors are further configured to execute the instructions to cause the computing system to insert, into the first density model and to areas corresponding to the at least one zone of interest, density contrast to obtain the second density model.

17. The computing system of claim 10, wherein the one or more processors are further configured to execute the instructions to cause the computing system to perform, on an initial velocity model, an FWI optimization scheme to obtain the velocity model.

18. The computing system of claim 10, wherein the one or more processors are further configured to execute the instructions to cause the computing system to subtract the first modeled data from the second modeled data to obtain the data difference.

19. A computer program product comprising computer-executable instructions that are stored on a non-transitory computer-readable medium and that, when executed by one or more processors, cause a computing system to:
obtain, based on seismic data, a velocity model of a subsurface region;
generate, based on the seismic data, a first density model corresponding to the subsurface region;
generate, based on the first density model, a second density model corresponding to the subsurface region, wherein the second density model comprises different densities corresponding to at least one zone of interest of the subsurface region;
obtain, based on the first density model and the velocity model, first modeled data;
obtain, based on the second density model and the velocity model, second modeled data;
obtain, based on the first modeled data and the second modeled data, data difference, wherein the data difference comprises additional modeled data corresponding to the different densities in the second density model;
perform, on the data difference, signal processing to obtain an envelope of the data difference; and
input, into a full waveform inversion (FWI) optimization scheme and as a weight function, the envelope to obtain an optimized subsurface model.

20. The computer program product of claim 19, wherein the computer-executable instructions, when executed by the one or more processors, further cause the computing system to:
perform, on the data difference, a Hilbert transform to obtain the envelope; and
perform thresholding, normalization, and scaling on the envelope before inputting the envelope,
wherein the FWI optimization scheme comprises at least one of:
a first elastic FWI optimization scheme comprising a density, a P-wave velocity, and an S-wave velocity;
a second elastic FWI optimization scheme comprising the P-wave velocity and an impedance;
a third elastic FWI optimization scheme comprising the P-wave velocity and the density;
a first multi-parameter FWI optimization scheme comprising the density, the P-wave velocity, the S-wave velocity, and one or more an anisotropy parameter or an attenuation parameter;
a second multi-parameter FWI optimization scheme comprising two or more components of the density, the P-wave velocity, the S-wave velocity, and one or more the anisotropy parameter or the attenuation parameter; or
an acoustic FWI optimization scheme comprising the P-wave velocity.
